(19) United States
(12) Patent Application Publication
(10) Pub. No.: US 2016/0361845 A1
(43) Pub. Date: Dec. 15, 2016

(54) Method for Casting Succulents

(71) Applicant: Michelle Weddle, Denver, CO (US)

(72) Inventor: Michelle Weddle, Denver, CO (US)

(21) Appl. No.: 15/170,160

(22) Filed: Jun. 1, 2016

Related U.S. Application Data
(60) Provisional application No. 62/173,572, filed on Jun. 10, 2015.

(51) Int. Cl. B29C 39/02; A41G 1/00

(52) U.S. Cl. CPC B29C 39/026; A41G 1/00; B29L 2031/722

(57) ABSTRACT

A method is disclosed for molding a live succulent plant and container or “pot” in silicone rubber, and casting both plant and container in a material that has the resultant assembled form of a live potted plant for use as home, office, event or other such decor. Although the method of this invention has been described with one preferred application of molding in silicone and casting said sculptural objects in a hard gypsum plaster called hydrostone®, other variations, applications, and embodiments may be developed using this method of invention by those skilled in the art of casting in materials such as plastics, ceramics, cements, rubbers or waxes; the wax casts usable in candle making and by foundries in the “lost wax casting” method, to create similar or identical casts in molten metals.

### PRIORITY

This application claims priority to Provisional Application No. 62/173,572 entitled “Method for Casting Succulents” and filed Jun. 10, 2015, the entirety of which is incorporated herein by reference.

### TECHNICAL FIELD

This application relates to a method and system for creating succulents.

### BACKGROUND OF THE INVENTION

Succulents are commonly grown as ornamental plants because of their striking appearance and desirability for decor of any kind. Many offices require such plants to enhance the decor and to make the office more enjoyable. However, an adequate investment of time in the maintenance of its natural beauty, including an adequate provision of defined quantities of sunlight, water, and proper drainage, specific to the particular needs of each individual species, is critical in the aiding and extension of its inherent lifespan. Exactly how much of each natural element is necessary for the preservation of such a particular species of live succulent plant is commonly unknown; such detailed information not readily accessible to amateur growers. Therefore, an object of this invention, is to provide a method of forming a unique and stylish sculptural object for use in home, office, or other such decor, so realistic in its likeness as to appear nearly indistinguishable from the live plant therefore, replacing the need and/or desire for a live succulent plant or other such common house plant.

Another object of this invention is to provide a method of forming a unique sculptural item for use in home, office, event and other such decor which is easy to carry out and inexpensive once the initial investment in mold making materials is made.

Yet another object of this invention is to provide a method of forming a unique sculptural object that is so realistic as to be willingly used in lieu of the cultural tradition of displaying natural, live flowers for occasions such as weddings and other such events, after which they can serve as parting gifts or favors that when handled properly, may last indefinitely.

Finally, another object of this invention is to provide a method of forming a unique sculptural object that can be gifted in lieu of flowers or potted plants as in the cultural tradition of expressing sympathy, congratulations or other such emotion.

### BRIEF DESCRIPTION OF THE DRAWINGS

FIG. 1 is a process flow chart of a method of creating a succulent sculpture closely resembling a live plant in one embodiment;

FIG. 2 is a perspective view of the assembled mold encapsulating the succulent ‘Haworthia species’ prototype in one embodiment;

FIG. 3 is a perspective view of the disassembled, inverted and segmented mold in one embodiment;

FIG. 4 is a succulent cast of the species ‘Haworthia’ in one embodiment;

FIG. 5 is a process flow chart of a method of one embodiment of creating a round container in which said succulent sculpture fits;

FIG. 6 is a perspective view of the succulent ‘Haworthia’ cast and the round container cast prepped for assembly in one embodiment;

FIG. 7 is a perspective view of the assembled end product; Haworthia cast and round container, in one embodiment;

FIG. 8 is a perspective view of the succulent ‘Echeveria Phil's Hybrid’ cast and a polyhedron container cast prepped for assembly in one embodiment;

FIG. 9 is a perspective view of the assembled end product; Echeveria Phil's Hybrid cast and polyhedron container cast in one embodiment.

### DETAILED DESCRIPTION

In one embodiment, a method of molding and casting succulents, and more particularly, to a method of molding and casting two sculptural objects (a succulent sculpture and a container sculpture), which when assembled, closely resembles a live, potted succulent plant is disclosed. “Succulents” are herein defined as any plant, including cacti, that a botanist would describe as having some parts that are more than normally thickened and fleshy, usually to retain water in arid climates or soil conditions. Other such examples of succulents include, but are not limited to, those of the species Graptoveria, Graptopetalum, Aloe, Sedum, Kalanchoe, Pachyeveria and Pachyphytum, Echeveria, Crassula, Aeonium, Sempervivums, and Cotyledon.

The method of FIG. 2 involves forming a prototype base 209 for the succulent plant cutting to rest on, comprising the steps of creating the prototype base 209, then the succulent prototype 212, assembling a mold around the succulent prototype 212, preparing and pouring silicone rubber, disassembling and inverting the mold, then extracting the prototype 212, after which a replica of the prototype 212 may be cast.

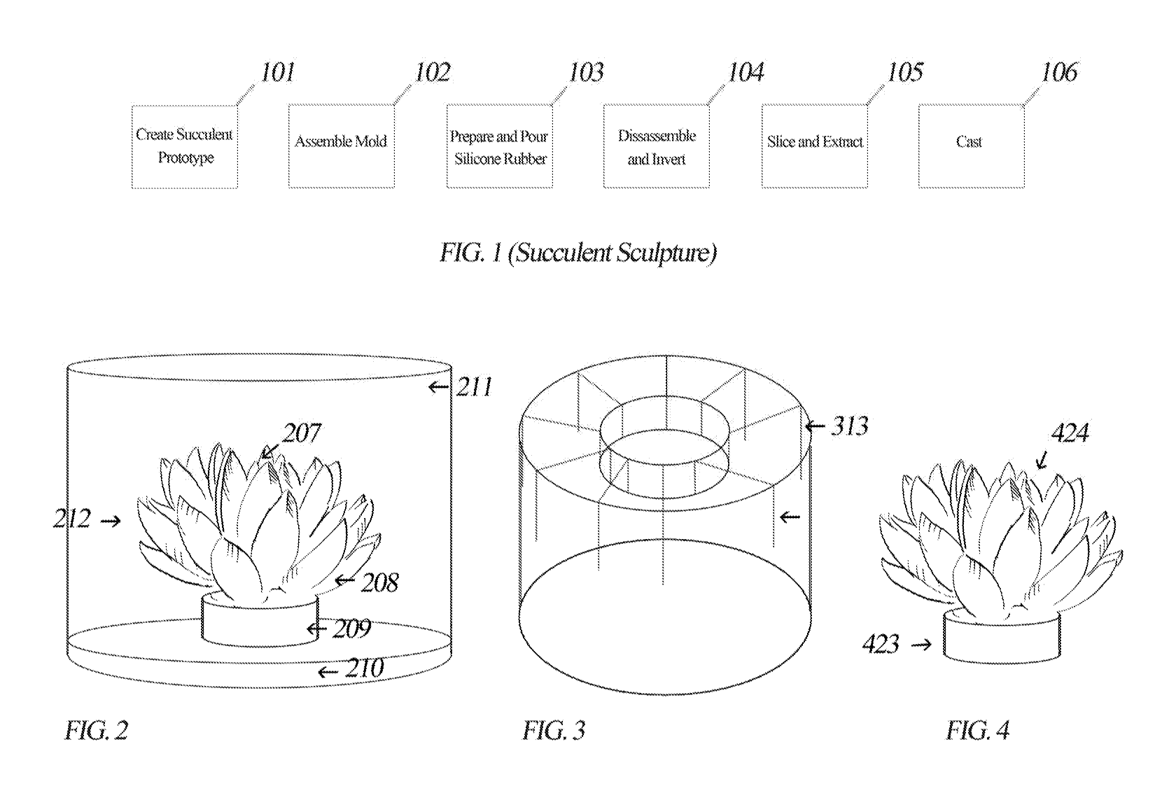

FIG. 1 is a process flow chart of a method of creating a succulent sculpture closely resembling a live plant in one embodiment. FIG. 1 is provided for illustrative purposes only and should not be deemed limiting. The method of FIG. 1 involves forming a cast succulent 424, as shown in FIG. 4, comprising the steps of creating a succulent prototype 212, assembling a mold, preparing and pouring silicone rubber, disassembling and inverting the mold, then slicing the mold and extracting the succulent prototype 212 in such a way as to allow for the successful casting and removal of a succulent sculpture 424. These steps are addressed below.

The first step 101 involves the creation of the succulent prototype 212. In one embodiment, a succulent of the species Haworthia (a variety aesthetically pleasing in form, therefore, practically suited as a sculptural object) is chosen as the specimen 207;. Within the species, a plant suitable in both overall dimension (proportional in size to the container to be incorporated) and in appropriate thickness where each leaf sprouts from the stem of the plant, must be chosen, as someone skilled in the art of mold making would understand, to allow for multiple successful casts. A mold that produces multiple successful casts reduces the need to create a new mold of the same species for each cast; thus, reducing the cost of, and time required for manufacturing. Other varieties of succulent species may be employed, including but not limited to, Echeveria Phil's Hybrid as depicted in FIG. 9, which provides similar desirable characteristics.

Once one such variety is chosen, the specimen 207 is gently rinsed of any foreign debris and sliced at the base of the stem. In one embodiment the specimen 207 is sliced at approximately ¼″ below the lowest leaf, though other distances can be utilized. The shape of the succulent cutting in its natural state can be improved upon in its aesthetic appeal by removing any leaves too thin or unshapely, and rearranging and/or adhering additional leaves to the stem with hot glue or other adhesive product or device.

In one embodiment, a prototype base 209 is selected for adhesion to the specimen 207. The prototype base 209 can comprise virtually any shape or size. In one embodiment a uniform prototype base 209 is selected which allows for ease of fit and interchangeability of each succulent with each created or purchased container. In one embodiment, a tin of a tea light candle filled with plaster, as shown in FIG. 2, is selected as the desired uniform prototype base 209 for each succulent cutting. The succulent prototype 212 to be molded is then created by adhering the prepared specimen 207 to the prototype base 209, such as the plaster filled tin. Excess glue can be applied around the stem of the succulent to provide a thicker girth (and thus strength) 208, and a wider cavity into which the chosen casting material will be poured. The plant may be dipped in a mild soap and water solution or gently sprayed with a ‘mold release’ product, and allowed to dry completely before the cutting is adhered to the prototype base 209 in the event the chosen plant specimen adversely adheres to the liquid silicone preventing easy extraction.

In step 102, a mold is assembled, such as shown in FIG. 2, around the succulent prototype 212. In one embodiment, the prototype 212 is adhered to a mold base 210. The prototype 212 can be adhered or attached with any method known in the art including paste, tacks, hot glue or other hot melt adhesive products, super glue, epoxy, and acrylic polymers etc. The mold base 210, in one embodiment, comprises a cork disk common used for craft or gardening projects. In one embodiment the cork disk 210 comprises a three inch diameter and a thickness of about ¼″. While described as being a cork disk, the mold base 210 can be made of virtually any material and can comprise virtually any shape. Petroleum jelly, or any other such lubricant such as an oil or grease, can be employed as a lubricant and thinly spread across the surface of the mold base 210.

A mold wall 211 is wrapped around the mold base 210 and adhered around the circumference or perimeter of the mold base 210 and along the length of the seam so as to not allow any liquid silicone to leak from the mold. The mold, as used herein, refers to the combination of the mold base 210 and the mold wall 211. The mold wall 211 can be any material which holds the silicone and prevents spillage. In one embodiment the mold wall comprises thick cardstock with a smooth/minimal-tooth finish. The mold wall 211 can be adhered with any method described herein, including via hot glue. Another lubricant such as petroleum jelly or an aerosol lubricant, or ‘mold release’ may be applied to the interior of the mold surface 211.

Many different materials can be utilized in the creation of the mold. For example, any flat object of any shape or size may serve as the mold base 210 and any flexible material such as a thin plastic or vinyl may be employed for use as the mold walls. As noted, in adhering the mold base 210 to the mold wall 211, any method of adhering, including adhesives, can be employed where applicable, as long as the materials will not negatively interfere with the chemical composition of the silicone rubber, adversely bond to the rubber in such a way as to prevent ease of disassembly, interfere with or retard the solidification of the silicone and/or interfere with the structural integrity of the mold, supporting the weight of the silicone employed by preventing collapse or leakage.

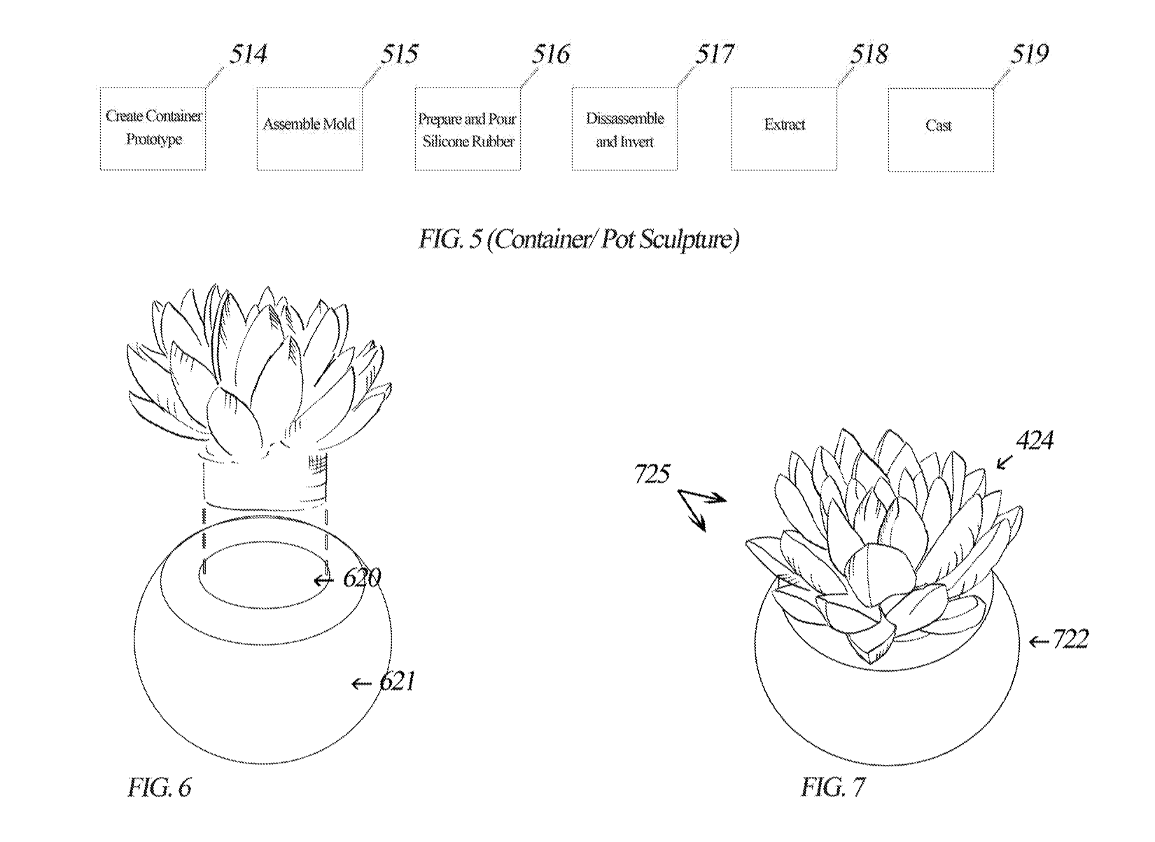

As noted, other objects beside the aforementioned tea light tin filled with plaster may be employed as the prototype base 209 without departing from the teaching or scope of protection of this invention. As will be noted below, in one embodiment the container prototype 621, created as described in FIG. 5, and shown in FIG. 6, is designed around the shape and/or size of the prototype base 209 of the succulent prototype 212, and a cavity of equal or larger dimension than the size or shape of the base is supplied and/or created, that the result may be aesthetically pleasing and practically suitable.

Step 103 involves the preparation and pouring of a mold material around the prototype 212 such that a mold is created around the prototype 212 with the external shape of the mold controlled by the mold wall 211 and the mold base 210. The mold material can comprise any material used to make molds. In one embodiment, the mold material comprises silicone rubber. In one embodiment, a brand of silicone rubber, namely Dragon Skin® High Performance Silicone Rubber is mixed 1A:1B by weight or volume. The rubber is vacuum degassed before pouring: pulling a vacuum to remove any air bubbles captured in the mixing of part A to part B effectively captures every minute detail of the prototype in exact proportion and scale. Employing this method and these materials creates a mold of such high quality that the resulting cast is nearly indistinguishable from the original plant. Other brands of silicone rubber with desired tear strength and flexibility may be employed without departing from the teaching or scope of protection of this invention. Depending on the type of silicone employed, a vacuum degasser may not be required to achieve the desired level of detail. A silicone mold may also be created by applying thin layers gradually, with any application tool such as a brush or wood spatula, allowing each layer to dry fully before applying additional layers, until the mold is thick enough to hold up under its own weight and rebound to its original shape after incisions are made.

In another embodiment, a hard, rigid mold comprised of at least two parts may also be created in plaster or some other solid material. Those skilled in the art of mold making and casting would understand that the most likely material used for casting in a rigid mold would be a flexible material such as a kind of rubber, though other materials including ceramics may be employed.

Step 104 involves the careful removal of all external parts of the mold created in step 102 including the mold base 210 and the mold wall 211. Once all external parts of the mold structure are removed, the mold is inverted so that the prototype base 209 of the prototype is visible from above perspective and the encapsulated plant is now upside down. This is illustrated in FIG. 3.

Step 105 involves the slicing and extraction of the succulent prototype 212. The prototype base 209 of the prototype is easily pried out of the rubber using some force of hand to reveal the stem of the succulent. The rubber used in the mold making process, in one embodiment, comprises a semi-transparent quality. Such a quality readily reveals the bottom-most layers of leaves. Very careful incisions 313 are made from the top of the rubber mold down, slicing into each leaf from the base to the tip along the sides of the mold. Each leaf removed reveals yet another layer of leaves into which more incisions will be made and leaves removed until the entire prototype has been effectively extracted. One skilled in the art of molding and casting will make additional incisions as needed into the interior of the mold where one may expect any casting material to be caught, resulting in a failed, broken cast.

Step 106 involves the casting of the succulent prototype shown in FIG. 4. First, each incision is painstakingly aligned back to its original position and a binding device is wrapped around the circumference to keep all segments of the mold in place. The binding device can comprise any device used to adhere pieces together, including but not limited to, a rubber band or elastic strap.

As noted, step 106 involves casting whereby a casting material is placed into the created mold. Virtually any type of casting material can be utilized. In one embodiment, a very strong, dense gypsum cement called hydrostone® is used as the casting material. In one embodiment, the hydrostone is combined with water at a temperature of 70° F., in a flexible plastic or rubber cup at the ideal ratio of 32 parts of water by weight per 100 parts of plaster. If the water temperature rises only slightly above 70° F., the slurry (water and plaster mixture) will set up too quickly and may become too thick to pour, trapping air and/or drying before the pouring of the cast is complete.

Next the plaster casting material is mixed and poured in the following steps: The plaster, once sifted into the water in the center of the cup, is allowed to slowly dissolve into the water for several seconds. A strong wire whisk, or other suitable device, is then used to rapidly stir the mixture until no lumps of plaster dust remain. Several seconds are spent tapping the sides of the container and thumping the cup on a hard surface to promote the release of any trapped air bubbles in the mixture that would create an imperfect cast.

Once most of the air bubbles are released, the mixture can be poured slowly into the mold, being careful not to pour too quickly, trapping excess air. The mold is then gently pounded on the table in an effort to release most trapped air from the tips of the leaves etc. To ensure all air bubbles are diminished, the entire mold may then be placed inside a pressure chamber or pressure pot that has been hooked up to an air compressor. With the door or lid of the pressure chamber closed and tightly secured, the mold may be subjected to 50-70 psi of pressure until the air bubbles have collapsed into the casting material and the casting material has set up. In one embodiment, the setting time is 30 minutes. Once adequate setting time has passed, the air compressor may be switched off, the pressure slowly released from the pressure chamber, and the mold removed. The cast is then allowed additional curing or drying time before an extraction of the cast is attempted. The dry period is dependent upon a variety of factors including the size of the cast, the type of casting material utilized, the humidity of the room, etc. In one embodiment, the dry period is greater than 2 hours.

During extraction the binding device is removed and the rubber segments are pulled away from the cast carefully and gradually, taking care not to break the cast upon removal. After extraction, the cast is allowed to dry for a period of time, such as 2-3 days, depending on size, materials, etc. Thereafter, in one embodiment, the cast succulent sculpture 424 can be optionally perfected with sanding or filing. At this stage, one may choose to paint the cast with any paint product suitable for use with plaster.

Although one embodiment of the method has been described with application of casting said sculptural objects in a hard gypsum plaster called hydrostone, other variations, applications, and embodiments may be developed by those skilled in the art of casting in materials such as other forms of plaster, plastics, ceramics, cements, or waxes (the wax casts usable in candle making and by foundries in the “lost wax casting” method to create similar or identical casts in molten metals), without departing from the teaching or scope of protection of this invention.

In one embodiment, a two-part ultra-low viscosity casting resin, namely Smooth Cast 300 Series is used as the casting material of choice. The liquid plastic is mixed thoroughly in a 1:1 volume ratio and slowly poured into a rubber mold that has been prepared with a mold release and allowed to dry. Although a mold release is not required when casting resins into silicone molds, it has the potential to extend the life of the mold by promoting ease of release of the resin from the silicone and slowing the deterioration of the mold by preventing cracks and/or tears in the rubber. In one embodiment, ‘Ease Release 200’ is carefully sprayed into each crevice and allowed to dry before resin is poured. The process of successfully eliminating potential air bubbles in the resin, mimics the process of removing air bubbles from plaster as described in step 106. The setting time of resin is comparably faster than that of plaster; approximately 3-20 minutes depending on the pot life of the casting resin chosen. The additional curing or drying period required after removal of the mold from the pressure pot, is dependent upon a variety of factors including the size of the cast, the type of resin utilized, the humidity of the room, etc. In one embodiment, the dry period is greater than 2 hours. The process of extracting the plastic cast from the mold mimics the process described for extracting a plaster cast as described in step 106. Many colorants or dyes may be added to the liquid resin before casting without departing from the teaching or scope of protection of this invention.

In one embodiment, the succulent sculpture 424 cast in any material may then be used as the succulent prototype 212 around which a mold may be built that results in an identical cast to the succulent sculpture 424. This sculpture 424, may be deemed the ‘Master Cast’ which may then be molded many times over, creating many casts identical to the original sculpture 424. The creation of a ‘Master Cast’ is beneficial in reducing the number of similarly proportioned plants of identical plant species that must be acquired and exhausted in the creation of new molds.

In one embodiment, a succulent sculpture 424 is cast in resin, namely Smooth Cast 300 Series, allowed to dry fully, and extracted from the mold. Another silicone mold is then prepared, assembled, poured, and dismantled, mimicking the processes for mold creation described in steps 102-104. The process of extracting the plastic cast from the silicone mold mimics the process described in step 105 for extracting succulent prototype 212, differing only in that the plastic cast may be removed in one solid piece. Removing the plastic cast in one solid piece is beneficial because the process of molding this plastic ‘master cast’ may be repeated indefinitely, as long as the cast remains in adequate, desirable molding condition.

Although one embodiment of the method has been described with application of creating said ‘Master Cast’ of the original succulent sculpture 424 in plastic, other variations, applications, and embodiments may be developed by those skilled in the art of mold making and casting in materials such as other forms of plastics, plaster, ceramics, cements, or waxes (the wax casts usable in candle making and by foundries in the “lost wax casting” method to create similar or identical casts in molten metals), without departing from the teaching or scope of protection of this invention.

Although one embodiment of the method has been described with application of molding said ‘Master Cast’ with silicone rubber, other variations, applications, and embodiments may be developed by those skilled in the art of mold making in materials such as other forms of silicones, resins, plastics, plaster, ceramics, cements, or waxes without departing from the teaching or scope of protection of this invention.

FIG. 5 is a process flow chart of a method of creating a container 621 suitably designed for above described succulent sculpture to rest within in one embodiment. Step 514 involves the creation of a container prototype 621, shown in FIG. 6. The container prototype 621 is used as the model upon which other containers will be based. The container prototype 621 can be virtually any shape or size used to house the cast succulent 424. The container prototype 621 can be round, square, and can comprise virtually any geometric shape.

In one embodiment, a container prototype 621 is created by drilling a hole of the size of the cast prototype base 423 into a wood object intended for other such purpose. In embodiments wherein a tea light tin is used as the prototype base 209, a hole of approximately 1.5 inches, which is the average size of a tea light tin, is drilled into a wood object approximately. In one embodiment, rough edges are sanded with a fine grit sandpaper until smooth and a thick coat of petroleum jelly or other such lubricant can be applied to the inside of the drilled hole to allow for easy extraction. While a wood object has been described, virtually any material can be utilized. For example, in one embodiment, the container prototype 621 may be a found object proportionate to the succulent prototype 212. As an example, FIG. 8 illustrates a container prototype 621 having a cavity 823 already suitable for the succulent sculpture to rest within, such as a tea light holder. The container may also include any such manufactured, or ready-made object such as a glass terrarium or ceramic container into which the succulent sculpture may be placed.

Returning back to FIG. 5, step 515 involves the process of assembling a mold around the container prototype 621. In one embodiment, this process mimics the process of constructing a mold as described in step 102 of FIG. 1.

Step 516 involves the process of preparing and pouring the silicone rubber. In one embodiment this process mimics the process described in step 103 of FIG. 1.

Step 517 involves the disassembly of the mold, similar to that as described in step 104, by tearing off the surrounding materials. The mold is also inverted to reveal the bottom of the container prototype 621.

Step 518 involves the extraction of the container prototype 621 by carefully taking a sharp blade and trimming away any excess silicone that may have seeped underneath the container in the mold making process. At this point, the container prototype 621 can be easily extracted without any incisions to the mold by peeling the silicone from the wood and popping it out.

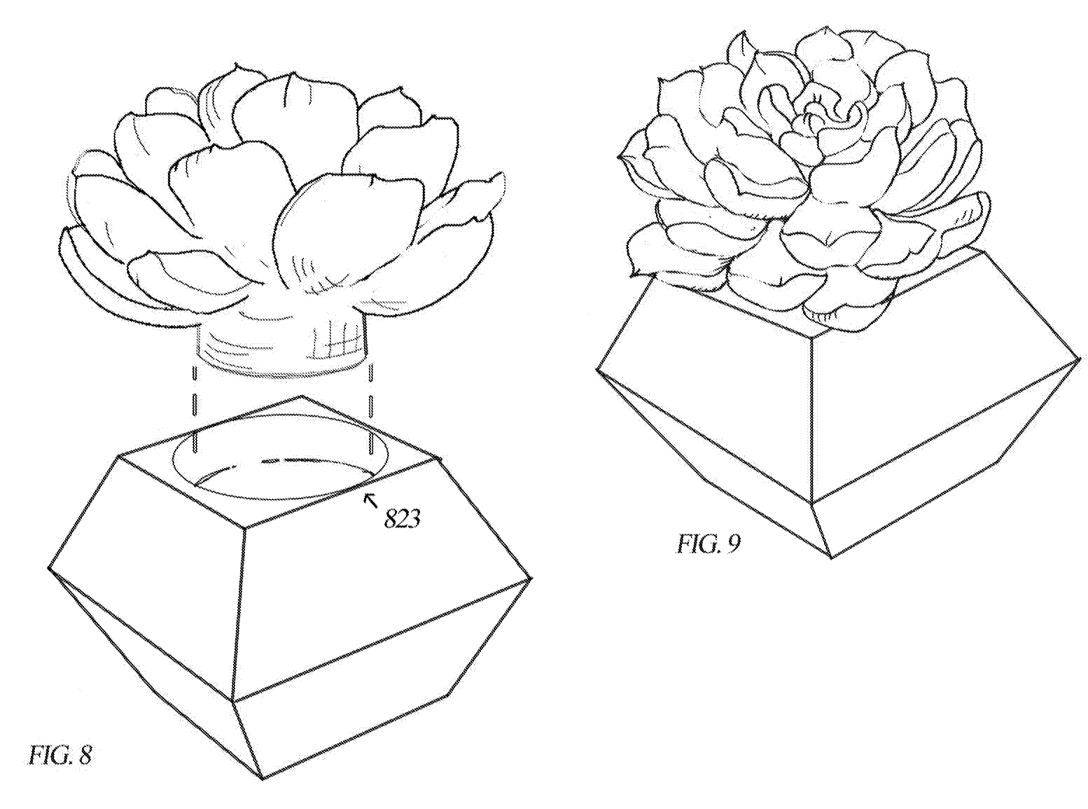

Step 519 involves the casting of the container that, in one embodiment, is created by using the same material and methods as described in step 106. Once the plaster has dried (within approximately 20 minutes), the container cast 722, as shown in FIG. 7, may be removed.

The cast may be allowed to air dry, which can vary from a day to a week or more, depending upon the materials used, the thickness, etc, or an oven may be used to speed up drying time. The best drying rooms or ovens provide uniform and rapid circulation with no ‘dead spots,’ having little or no air movement, equal temperature throughout the entire area, and provisions for exhausting a portion of the air while replacing it with fresh air. High humidity surrounding the drying room or oven inhibits the efficiency of the drying because the air pulled into the room is incapable of picking up much moisture from the cast pieces. The maximum temperature at which hydrostone® casts are safe from calcification is 120° F. (49° C.). With substantial free water in the cast piece, higher drying temperatures can be used without difficulty. As drying progresses, the temperature must be reduced to prevent calcification. Before removing casts from the dryer, the temperature should approach that of the area around the dryer to prevent thermal shock. (www.usg.com)

Any small air bubbles may be filled by hand with plaster slurry or a soft, sandable filler found at any general hardware store. In one embodiment, the container cast 722 is lightly sanded, and either left in the pristine white color of the hydrostone or other natural color of the plaster utilized, or painted with any sort of paint that adheres easily to plaster. The cast container 722 is ready for assemblage with a cast succulent 424 to create the final product 725 as shown in FIG. 7.

In one embodiment the cast succulent 424 is inserted into the cavity of the container cast 722. In one embodiment the cast succulent 424 is adhered to the container cast 722 via any adhering means known in the art. In other embodiments, however, the cast succulent 424 is simply placed within the container cast 722 without adhering. If the cast succulent 424 is not adhered to the container cast 722, the cast succulent 424 can be placed in other container casts 722, or a manufactured, purchased container for variety. Such embodiments increase the flexibility and functionality of the final product 725.

While one embodiment has been described wherein the cast succulent 424 is separately cast from the container cast 722, in other embodiments the two can be cast as one object. For example, in one embodiment the prototype base 209 is used as the final container. Thus, when the prototype base 209 and the succulent specimen 207 are cast, the resulting product is a single cast which comprises both a cast succulent and a container cast.

Although the method of this invention has been described with one preferred application in two complete variations, such as those shown in FIG. 7 and FIG. 9, of molding the container prototype 621 with silicone rubber and casting in hydrostone (or some other such plaster product), other variations, applications, and embodiments may be developed using this method of invention by those skilled in the art of mold making and casting in materials such as plastics, ceramics, cements, or waxes. For example, the silicone rubber molds herein described, may be used to create casts first in wax, then in molten metals such as bronze, brass or stainless steel in a process well known for centuries as the ‘lost wax casting method.’

In one embodiment, for example, a hot wax product such as ‘machinable wax’ may be poured into the silicone rubber molds to create an even, uniform wax thickness of about 3/16th's of an inch. After the wax cools, it is removed from the rubber mold, leaving a highly detailed positive image of the sculpture. The wax replica is then ‘chased’ and sprues (wax bars) are added. A ‘pouring cup’ is carefully attached to the wax pattern to insure the proper flow of metal and to control the metal solidification. Up to a dozen layers of ceramic are applied to the wax positive ensuring that the wax pattern and sprues are fortified by an outer ceramic shell that becomes the final mold after the shell is fired and the wax is “lost” (melted away). The shells (still containing wax) are placed into the kiln and heated to 1600° F. At this point the wax is ‘lost’ or (melted away) leaving a hollow ceramic shell that is ready to accept the molten bronze. The molten metal (bronze at about 2000° F. or stainless steel at about 2870° F.) is poured into the shell and then allowed to cool. Once the ceramic shell is removed, the metal and sprues are cut off. A sandblaster may be used to remove any remaining ceramic and do a final ‘cleaning’ of the metal cast. Some final welding may be employed to create any final touch ups. A variety of finishes and chemicals may be applied to the surface of the bronze to create numerable color effects.

While the invention has been particularly shown and described with reference to a preferred embodiment, it will be understood by those skilled in the art that various changes in form and detail can be made therein without departing from the spirit and scope of the invention.

### ADDITIONAL DESCRIPTION

The following clauses are offered as further description of the disclosed invention.
1. A method of casting succulents, said method comprising the steps of:
   a. creating a succulent prototype;
   b. assembling a mold, wherein said mold comprises a mold base and a mold wall;
   c. pouring a mold material into said mold;
   d. removal of said mold base and said mold wall;
   e. extracting said succulent prototype by slicing said mold material into at least two mold material pieces;
   f. realigning said at least two mold material pieces to form a created mold;
   g. placing casting material into said created mold; and
   h. drying to form a cast succulent.
2. The method according to clause 1 wherein said creating step comprises adhering a prototype base to the bottom of a succulent specimen.
3. The method according to clause 2 wherein said prototype base comprises a tin of tea light candle.
4. The method according to clause 2 wherein said succulent specimen is dipped in soap and water prior to adhering said succulent specimen to said prototype base.
5. The method according to any preceding clause wherein said mold wall is adhered to the perimeter of said mold base.
6. The method according to any preceding clause wherein said mold wall comprises lubricant on an internal surface.
7. The method according to any preceding clause wherein said mold material comprises silicone rubber.
8. The method according to any preceding clause wherein said pouring further comprises degassing said mold material prior to said pouring.
9. The method according to any preceding clause wherein said removal further comprises inverting said succulent prototype.
10. The method according to any preceding clause wherein said casting material comprises hydrostone.
11. The method according to any preceding clause wherein said placing further comprises gently pounding said created mold to release trapped air.
12. The method according to any preceding clause wherein said created mold is bound together with a binding device.
13. The method according to any preceding clause further comprising sanding said casted succulent after said drying step.
14. The method according to any preceding clause further comprising painting after said drying step.
15. The method according to any preceding clause further comprising the step of placing said casted succulent into a container.
16. The method according to clause 15 wherein said container is a cast container.
17. The method according to any preceding clause wherein said creating comprises trimming a leaf.
18. The method according to any preceding clause wherein said succulent is sliced at about ¼ of an inch below the lowest leaf.
19. The method according to any preceding clause wherein said succulent comprises a succulent selected from the group consisting of Graptoveria, Graptopetalum, Aloe, Sedum, Kalanchoe, Pachyeveria and Pachyphytum, Echeveria, Crassula, Aeonium, Sempervivums, and Cotyledon.
20. A cast succulent formed by the method of claim 1.

I claim:

1. A method of casting succulents, said method comprising the steps of:
a. creating a succulent prototype;
b. assembling a mold, wherein said mold comprises a mold base and a mold wall;
c. pouring a mold material into said mold;
d. removal of said mold base and said mold wall;
e. extracting said succulent prototype by slicing said mold material into at least two mold material pieces;
f. realigning said at least two mold material pieces to form a created mold;
g. placing casting material into said created mold; and
h. drying to form a cast succulent.

2. The method of claim 1 wherein said creating step comprises adhering a prototype base to the bottom of a succulent specimen.

3. The method of claim 2 wherein said prototype base comprises a tin of tea light candle.

4. The method of claim 2 wherein said succulent specimen is dipped in soap and water prior to adhering said succulent specimen to said prototype base.

5. The method of claim 1 wherein said mold wall is adhered to the perimeter of said mold base.

6. The method of claim 1 wherein said mold wall comprises lubricant on an internal surface.

7. The method of claim 1 wherein said mold material comprises silicone rubber.

8. The method of claim 1 wherein said pouring further comprises degassing said mold material prior to said pouring.

9. The method of claim 1 wherein said removal further comprises inverting said succulent prototype.

10. The method of claim 1 wherein said casting material comprises hydrostone.

11. The method of claim 1 wherein said placing further comprises gently pounding said created mold to release trapped air.

12. The method of claim 1 wherein said created mold is bound together with a binding device.

13. The method of claim 1 further comprising sanding said casted succulent after said drying step.

14. The method of claim 1 further comprising painting after said drying step.

15. The method of claim 1 further comprising the step of placing said casted succulent into a container.

16. The method of claim 15 wherein said container is a cast container.

17. The method of claim 1 wherein said creating comprises trimming a leaf.

18. The method of claim 1 wherein said succulent is sliced at about ¼ of an inch below the lowest leaf.

19. The method of claim 1 wherein said succulent comprises a succulent selected from the group consisting of Graptoveria, Graptopetalum, Aloe, Sedum, Kalanchoe, Pachyeveria and Pachyphytum, Echeveria, Crassula, Aeonium, Sempervivums, and Cotyledon.

20. A cast succulent formed by the method of claim 1.
